(19) United States
(12) Patent Application Publication
(10) Pub. No.: US 2003/0088486 A1
(43) Pub. Date: May 8, 2003

(54) System and method for managing inspection of cargo

(76) Inventors: Alex Lee, Tu-Chen (TW); David Luo, Tu-Chen (TW); Wenzhen Ma, Shenzhen (CN); Ying Tang, Shenzhen (CN); Wenbo Mao, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/077,437

(22) Filed: Feb. 14, 2002

(30) Foreign Application Priority Data
Nov. 7, 2001 (TW) 90127646

(51) Int. Cl. G06F 17/60

(52) U.S. Cl. 705/28

(57) ABSTRACT

A system and method for managing inspection of cargo according to cargo information integrated in a unified communications network. The system comprises a plurality of operation terminals (8) for inputting cargo information. A central management unit (1) is connected with the operation terminals via a communications network (13) for receiving and storing the cargo information. A gate management system (2) is connected to the central management unit via the communications network for controlling passage of the cargo according to the cargo information. An inspection management system (3) is connected to the central management unit via the communications network for controlling inspection of the cargo according to the cargo information. The central management unit obtains cargo inspection requirements from an external system (5) of an external organization via the communications network.

### BACKGROUND OF THE INVENTION

1. Field of the Invention

This invention relates to means for managing inspection of cargo, and more particularly, to systems and methods that integrate incoming and outgoing cargo information in a unified communications network for managing inspection of incoming and outgoing cargo.

2. Description of Related Art

Web communications technology advances are continually being used to improve the processes of production, procurement and sales. Manufacturing enterprises are facing increasingly tough competition, and are constantly striving to speed up production and provide better service to customers. However, conventional systems and methods for streamlining the process of cargo inspection by using web technology and communications networks are still not satisfactory.

An efficient delivery system is especially useful for large factory premises which may have hundreds of loads of cargo received and dispatched daily. At a large factory, inspection and checking of cargo normally involves complicated physical and manual procedures. Such procedures are particularly prone to human error. In addition, up-to-date information on cargo being inspected cannot normally be obtained in real time. Furthermore, updating of cargo information is generally time-consuming and unwieldy.

Conventionally, an inspector inspects cargo according to a hardcopy delivery advice accompanying the cargo, and according to a delivery schedule compiled by the department of the organization that is responsible for inspection. The delivery schedule may contain information for one day or for several days. In a large factory, the delivery schedule may be too long and complicated for the inspector to easily locate the desired information. In addition, the delivery schedule is usually compiled several days before the actual inspection day. The delivery schedule does not include last-minute changes, and this frequently causes confusion and mistakes.

Moreover, because conventional inspection procedures are largely manual, inspection results are generally checked by the factory's auditors only after all inspections in one day have been completed. As a result, auditors cannot obtain real time inspection information and cannot promptly respond to any anomalies found.

Another problem many factories encounter in procurement is that suppliers do not deliver in time or in accordance with applicable supply contracts. In such instances, the factory may either accept the cargo at a discount price, or alternatively refuse to accept the cargo and subsequently claim against the supplier. However, there is no system that can strictly control delivery of cargo in such circumstances.

U.S. Pat. No. 6,138,291 discloses a system and method for monitoring shipping containers and inventory. The system provides computer means for monitoring and recording location and load status of shipping containers related to a facility with an associated yard. Referring to FIG. 9, such container monitoring and control system (CMCS) 60 includes a central processing unit 61 for receiving and processing container related data, a database 62, a virtual inventory database 63, one or more data input terminals 64 which may be local or remotely located from the CMCS 60, one or more monitors 65, communication links 66 to a remote computer system, remote container data transceivers 67, and one or more printers 68 for producing hardcopy reports on container related data. One or more of the data input terminals 64 and monitors 65 may be located at a gate for input to the CMCS 60 of data obtained from incoming and outgoing containers. A carrier management information system (MIS) 70, a supplier MIS 71 and a plurality of customer MISs (72, 73, only two shown) are connected with the CMCS 60 via the communication links 66, and can interchange information with the CMCS 60.

The system in U.S. Pat. No. 6,138,291 can obtain real time data on containers and inventory for logistical control. However, the system cannot integrate the obtained real time data into a unified communications network for cargo inspection. In addition, the system does not provide tracking and monitoring of cargo that is in transit to its final destination.

Still another problem in the control of incoming and outgoing cargo is that some cargo should be inspected by an external organization before being received or dispatched. For example, cargo imported from or exported to overseas locations should be inspected by the relevant customs authority. Conventional processes of handling such cargo for inspection are unwieldy and time-consuming. Generally, a customs clearance department in a factory provides necessary documents to the external organization. After the cargo and related documents have been inspected by the external organization, the cargo is received or dispatched. However, a large factory may have hundreds of loads of such cargo received and dispatched daily. The customs clearance department needs to employ large numbers of staff and equipment, resulting in high costs.

Accordingly, what is needed is a system and method that can easily and conveniently integrate information relating to inspection of incoming and outgoing cargo. What is also needed is a system and method that enables a factory and an external organization to conveniently exchange information relating to inspection of incoming and outgoing cargo.

### SUMMARY OF THE INVENTION

A primary object of the present invention is to provide a system for conveniently managing cargo inspection by means of integrating incoming and outgoing cargo information in a unified communications network.

Another object of the present invention is to provide a method for conveniently managing cargo inspection by means of integrating incoming and outgoing cargo information in a unified communications network.

A further object of the present invention is to provide a system and method enabling convenient information interchange between a factory and an external organization regarding inspection of incoming and outgoing cargo.

In one aspect of the present invention, a system for managing inspection of cargo is shown. The system comprises a plurality of operation terminals for inputting cargo information; a central management unit connected with the operation terminals via a communications network for receiving and storing the cargo information; a gate management system connected to the central management unit via the communications network for controlling passage of the cargo according to the cargo information, the gate management system including a server for receiving the cargo information from the central management unit and for storing cargo passage records, and further including at least one operation terminal for checking the cargo against the cargo information and for updating the cargo passage records; and an inspection management system connected to the central management unit via the communications network for inspecting the cargo according to the cargo information, the inspection management system including a server for receiving the cargo information from the central management unit and for storing cargo inspection records, and further including at least one operation terminal for inspecting the cargo according to the cargo information and for updating the cargo inspection records.

In another aspect of the present invention, a method for managing inspection of cargo is shown. The method comprises the steps of: inputting cargo receipt and dispatch schedules and incoming and outgoing cargo information to a central management unit via a communications network; the central management unit obtaining cargo inspection requirements from an external system via the communications network; integrating the cargo receipt and dispatch schedules, incoming and outgoing cargo information and cargo inspection requirements in the central management unit; transmitting the integrated information to a gate management system for controlling passage of incoming and outgoing cargo; and transmitting the integrated information to an inspection management system for inspecting the incoming and outgoing cargo.

These and other objects, features, and advantages of the present invention will become more fully apparent from the following description and appended claims, or may be learned by practice of the invention as set forth hereinafter.

### BRIEF DESCRIPTION OF THE DRAWINGS

FIG. 1 is a schematic diagram of a system for managing inspection of incoming and outgoing cargo via a communications network, in accordance with a preferred embodiment of the present invention;

FIG. 2 is an information flowchart of the system shown in FIG. 1;

FIG. 3 is an operation flowchart of information concerning receipt of incoming cargo, in accordance with the preferred embodiment of the present invention;

FIG. 4 is an operation flowchart of information concerning dispatch of outgoing cargo, in accordance with the preferred embodiment of the present invention;

FIG. 5 is a schematic diagram of hardware for implementing inspection of cargo using a gate management system and an inspection management system of the system shown in FIG. 1;

FIG. 6 is an operation flowchart for inspecting incoming cargo, in accordance with the preferred embodiment of the present invention;

FIG. 7 is an operation flowchart for inspecting outgoing cargo, in accordance with the preferred embodiment of the present invention;

FIG. 8 is a schematic diagram of a global positioning system (GPS) of the system shown in FIG. 1; and

FIG. 9 is a schematic diagram of a conventional system and method for monitoring shipping containers and inventory.

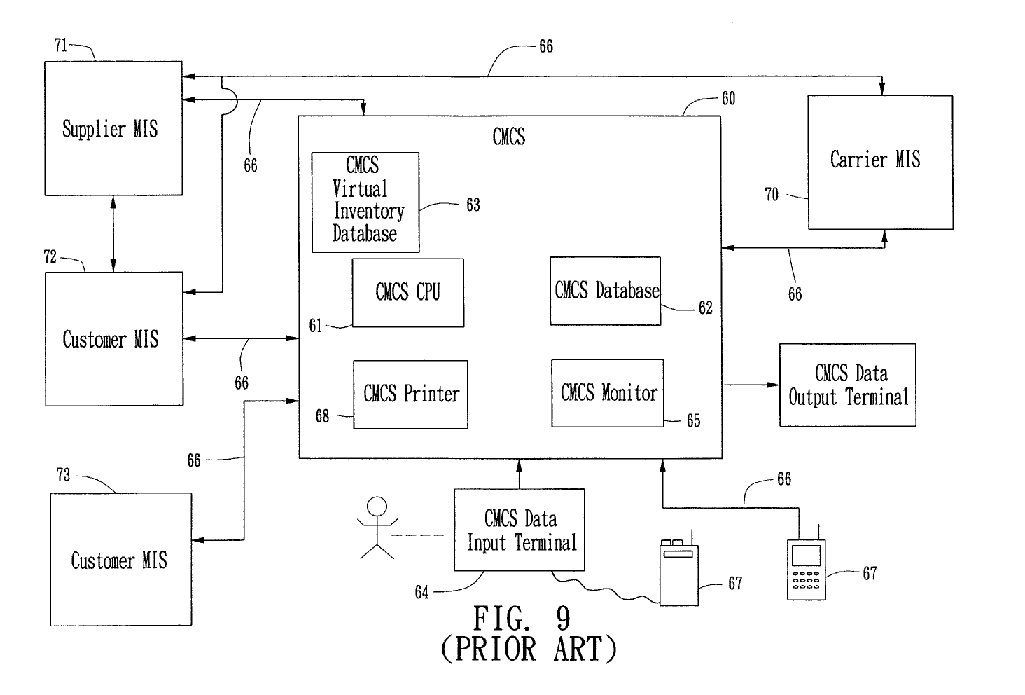

### DETAILED DESCRIPTION OF THE INVENTION

Reference will now be made to the drawing figures to describe a preferred embodiment of the present invention in detail.

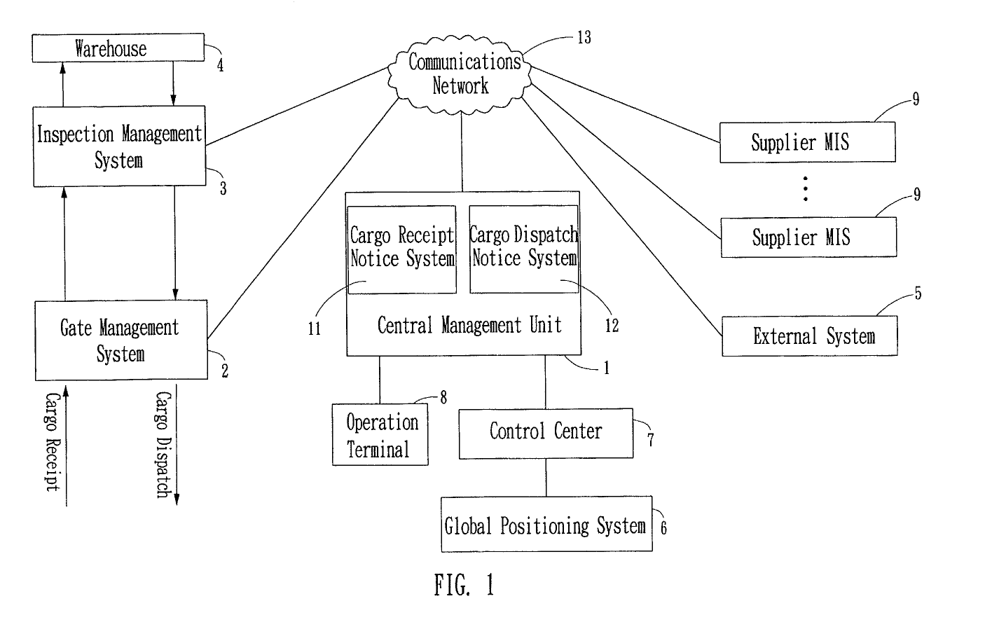

FIG. 1 is a schematic diagram of a system for managing inspection of incoming and outgoing cargo via a communications network, in accordance with the preferred embodiment of the present invention. The cargo inspection management system comprises a central management unit 1 for receiving and processing incoming and outgoing cargo information, a gate management system 2 located at a gate of a factory for controlling passage of cargo in and out of the factory, an inspection management system 3 installed in an inspection station of the factory for inspecting cargo according to data stored in the central management unit 1, and a global positioning system (GPS) 6 for tracking delivery routes and locating positions of cargo being delivered.

The central management unit 1 comprises a cargo receipt notice system 11 for managing cargo receipt information, and a cargo dispatch notice system 12 for managing cargo dispatch information. A plurality of operation terminals 8 (only one shown) are connected to the central management unit 1. The operation terminals 8 function as human interfaces for inputting cargo receipt and dispatch information to the central management unit 1. Input information on cargo comprises contract number, cargo name, quantity, specifications, delivery date, and vehicle information.

One or more supplier management information systems (MISs) 9 are connected with the central management unit 1 via a communications network 13, for interchanging information with the central management unit 1.

An external system 5 is also connected with the central management unit 1 via the communications network 13, for obtaining desired information from the central management unit 1. The external system 5 may be located in an external organization set up by a government agency such as customs which is in charge of inspecting imported and exported cargo.

The gate management system 2 controls passage of cargo in and out of the factory according to the cargo information recorded in the central management unit 1. When incoming and outgoing cargo matches information recorded in the central management unit 1, the cargo is allowed to pass through the gate of the factory. The information to be checked and confirmed at the gate may include cargo delivery date, vehicle information, and data required by the external organization.

The gate management system 2 and the inspection management system 3 are connected with the central management unit 1 via the communications network 13, and obtain delivery information from the central management unit 1. Before cargo is delivered inside the factory, a vehicle loaded with the cargo arrives at the gate. An operator at the gate obtains data from the central management unit 1 for checking against cargo information accompanying the vehicle itself. If the accompanying cargo information matches the data in the central management unit 1, the vehicle is allowed to pass through the gate and arrive at the inspection station. Another operator at the inspection station inspects the cargo with reference to data recorded in the central management unit 1. If the cargo meets acceptable standards, it is taken into a warehouse 4 of the factory. Similarly, when shipping cargo out from the factory, the cargo is taken out from the warehouse 4 and collected at the inspection station. The cargo is inspected and approved to be in acceptable condition for delivery, as required by data recorded in the central management unit 1. The cargo is sealed, and allowed to arrive at the gate. An operator at the gate checks whether relevant documents and information accompanying the cargo match corresponding data provided by the central management unit 1. If the documents and information match the data, the cargo is allowed to pass out through the gate.

The GPS 6 is provided for tracking and monitoring delivery of cargo, via a satellite that identifies the location of the cargo and tracks the delivery route. The GPS 6 is connected to the central management unit 1 through a control center 7. Operators at the control center 7 can locate the real time position of the cargo, and monitor the whole process of cargo delivery.

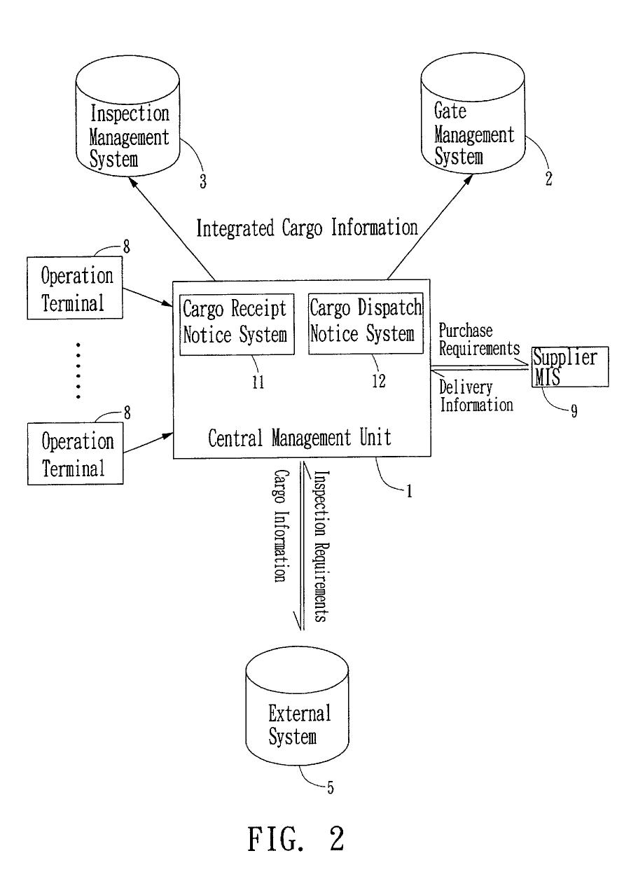

FIG. 2 is an information flowchart of the system for managing inspection of incoming and outgoing cargo. Firstly, operators input cargo receipt and dispatch information into the central management unit 1 via the operation terminals 8, according to production schedules, current inventory and sales contracts. The operation terminals 8 are located in a procurement department and in a shipping department of the factory. The shipping department provides sales contract data to the cargo dispatch notice system 12 in the central management unit 1. Such data includes cargo name, dispatch dates, and other information shown on a sales contract. The procurement department inputs purchase requirements into the cargo receipt notice system 11 in the central management unit 1, according to production schedules and current inventory. Any of the supplier MISs 9 can obtain the purchase requirements from the cargo receipt notice system 11 via the communications network 13. If a supplier can meet the purchase requirements, the supplier digitally signs into the cargo receipt notice system 11. The supplier confirms its agreement to supply the cargo, and inputs delivery information. The delivery information includes delivery date, delivery vehicle information, and driver information.

The cargo receipt and dispatch information are integrated in the central management unit 1, which then automatically generates a cargo receipt schedule and a cargo dispatch schedule. The said schedules accord with the input delivery date information and dispatch date information. The cargo receipt schedule and the cargo dispatch schedule are transmitted to the external system 5 via the communications network 13. The external system 5 can check the cargo information in the cargo receipt schedule and the cargo dispatch schedule, and electronically flag in the central management unit 1 cargo which should be inspected in detail by the external organization.

The cargo receipt and dispatch schedules and the inspection requirements of the external system 5 are transmitted to the gate management system 2 and the inspection management system 3 via the communications network 13.

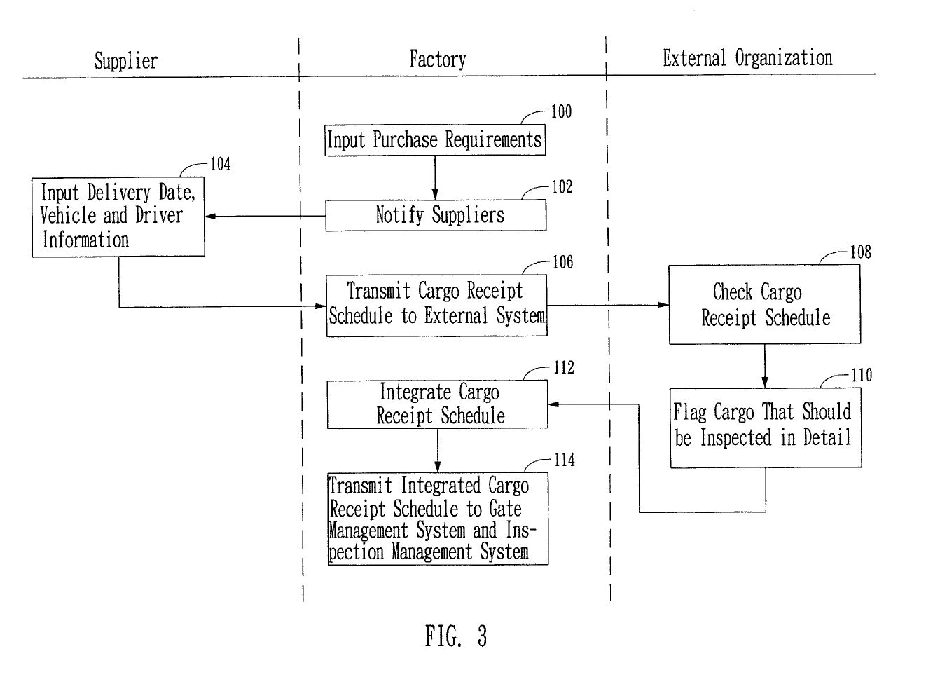

FIG. 3 is an operation flowchart of information concerning receipt of incoming cargo. Firstly, in step 100, the procurement department inputs purchase requirements into the cargo receipt notice system 11 in the central management unit 1. The purchase requirements include name of required cargo, specifications, quantity, unit price, and delivery date. In step 102, the procurement department notifies suppliers of the purchase requirements by posting the purchase requirements on the cargo receipt notice system 11. If the cargo is needed urgently, the procurement department contacts suppliers by electronic means such as phone or fax to request that a prompt response be made via the communications network 13. If the cargo is not needed urgently, suppliers in any event regularly visit the cargo receipt notice system 11 and obtain the purchase requirements. If a supplier can meet the purchase requirements, in step 104, the supplier inputs delivery information into the cargo receipt notice system 11 via the communications network 13. The delivery information includes delivery date, delivery vehicle and driver information. In step 106, the confirmed delivery information is combined with the input purchase requirements to generate a cargo receipt schedule, and the cargo receipt schedule is transmitted to the external system 5 via the communications network 13. In step 108, the external organization checks the cargo receipt schedule held in the external system 5. In step 110, the external organization electronically flags in the external system 5 cargo that should be inspected in detail. In step 112, the inspection requirements of the external system 5 are integrated into the cargo receipt schedule. In step 114, the integrated cargo receipt schedule is transmitted to the gate management system 2 and the inspection management system 3 via the communications network 13.

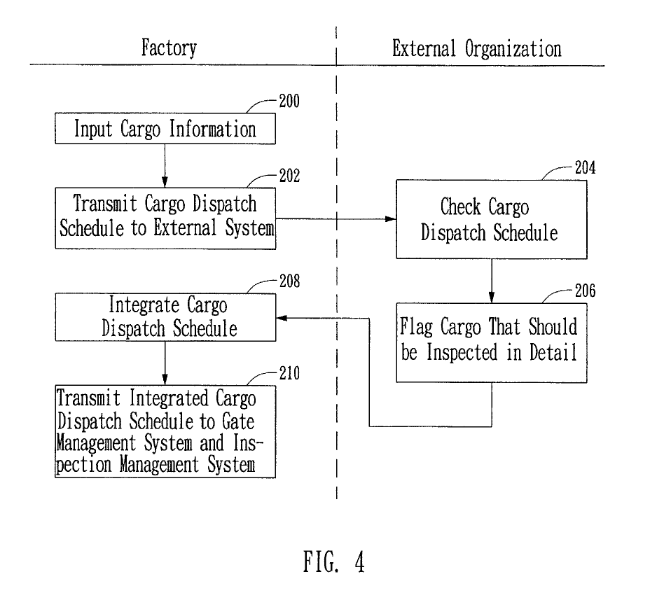

FIG. 4 is an operation flowchart of information concerning dispatch of outgoing cargo. Firstly, in step 200, the shipping department inputs original cargo information into the cargo dispatch notice system 12 according to the sales contract. In step 202, a cargo dispatch schedule is generated according to the original cargo information, and transmitted to the external system 5 via the communications network 13. In step 204, the external organization checks the cargo dispatch schedule held in the external system 5. In step 206, the external organization electronically flags in the external system 5 cargo that should be inspected in detail. In step 208, the inspection requirements of the external system 5 are integrated into the cargo dispatch schedule. In step 210, the integrated cargo dispatch schedule is transmitted to the gate management system 2 and the inspection management system 3 via the communications network 13.

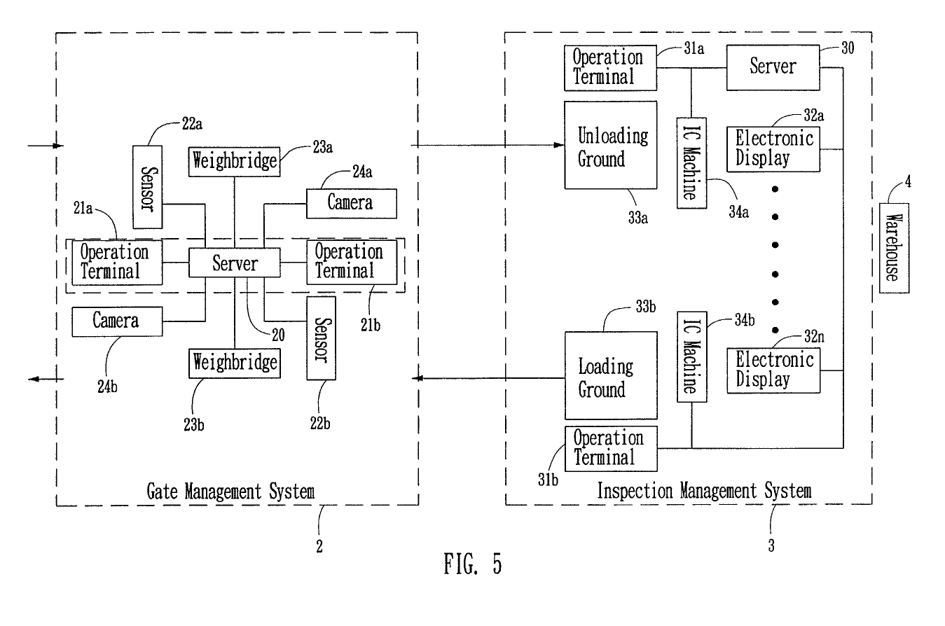

FIG. 5 is a schematic diagram of hardware for implementing inspection of cargo using the gate management system 2 and the inspection management system 3.

Also referring to FIG. 1, the gate management system 2 comprises a server 20 which is linked with the central management unit 1 via the communications network 13 and which can obtain cargo receipt and dispatch schedules from the central management unit 1, a couple of operation terminals 21a, 21b connected to the server 20 for checking the cargo against the cargo information in the central management unit 1 and for updating cargo passage records, a couple of sensors 22a, 22b for detecting vehicle information from an IC board attached to each delivery vehicle, a couple of weighbridges 23a, 23b for weighing cargo and transmitting measured weights to the server 20, and a couple of video cameras 24a, 24b for recording a video view of the whole checking process. The sensors 21a, 21b, the weighbridges 22a, 22b and the video cameras 24a, 24b are respectively connected to the server 20 by a communications converter (not shown in FIG. 5). Therefore, the detected vehicle information, the cargo weight and the video view are automatically input to the server 20. The control center 7 and the external system 5 obtain such input information, weight and video view in real time via the communications network 13 (see FIG. 1).

The inspection management system 3 comprises a server 30 which is in communication with the central management unit 1 via the communications network 13 and which can obtain cargo receipt and dispatch schedules from the central management unit 1, a couple of operation terminals 31a, 31b connected to the server 30 for inspecting the cargo according to the cargo information in the central management unit 1 and for updating the cargo inspection records, a plurality of electronic displays 32a-32n connected to the server 30 for displaying information on the cargo being inspected, an unloading ground 33a and a loading ground 33b which are the places for inspecting incoming and outgoing cargo respectively, and a couple of IC card readers 34a, 34b connected to the server 30 for confirming the identity of an inspector who conducts the inspection via an IC card that stores the inspector's personal information. The inspection results are also input to the server 30, from which the control center 7 and the external system 5 get real time information on inspection via the communications network 13.

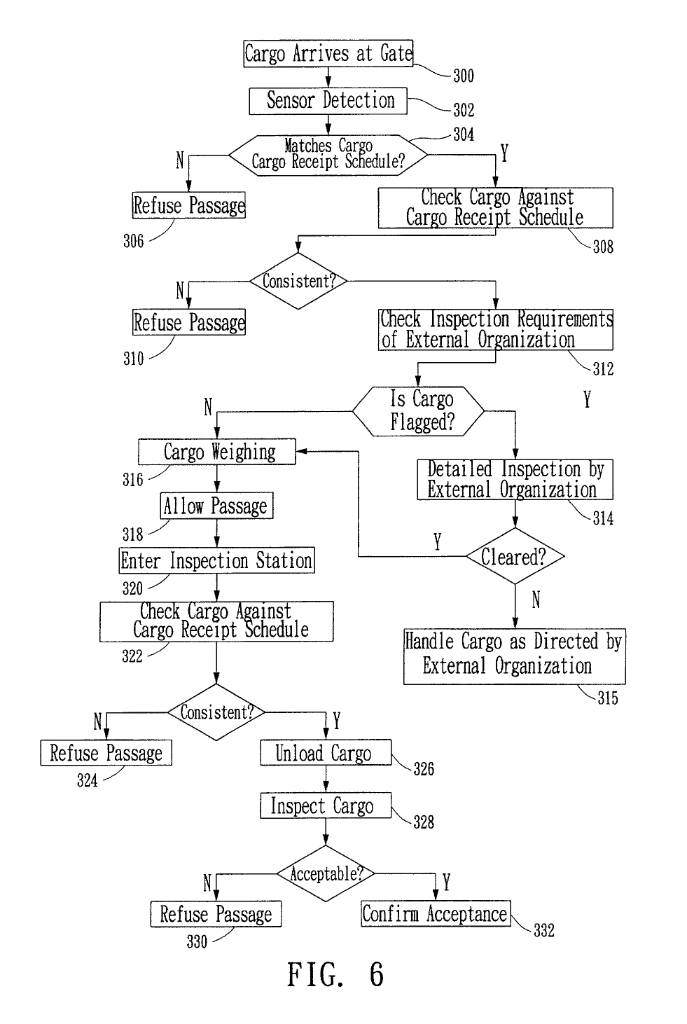

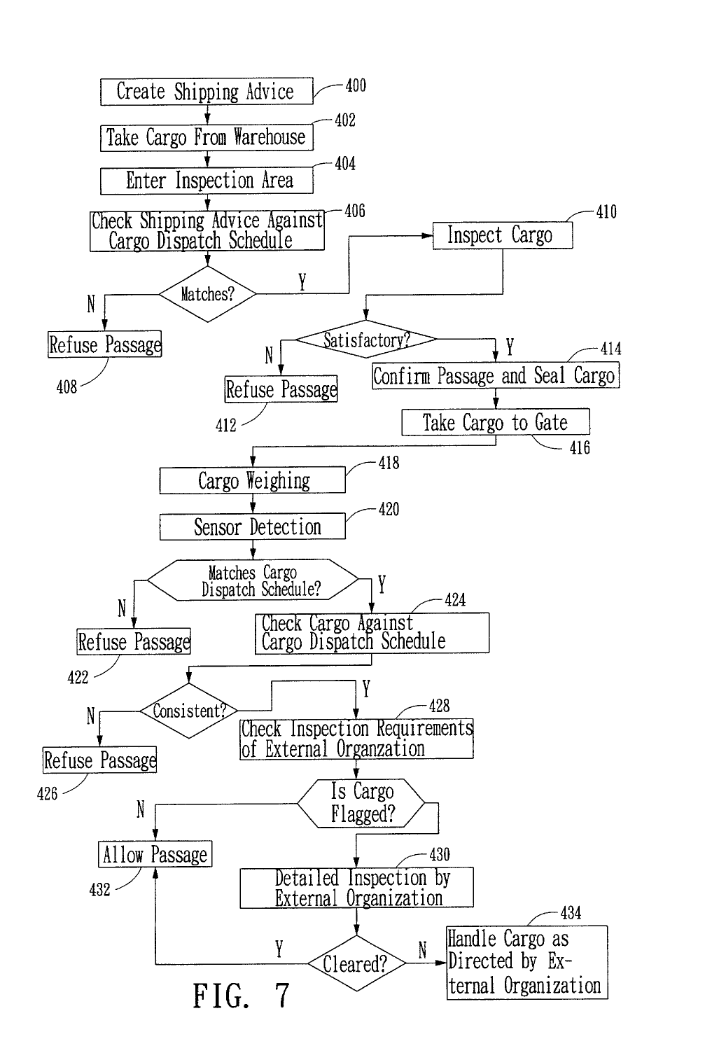

When cargo is delivered to the factory, the cargo firstly arrives at the gate. The cargo is checked to determine whether it meets passage requirements recorded in the central management unit 1. If the cargo meets the passage requirements, it is taken to the inspection station for physical inspection. If the cargo does not meet the passage requirements, it is refused passage. After the cargo is inspected in the inspection station and found to meet acceptable standards, it is taken into the warehouse 4. Similarly, when cargo is dispatched from the factory, it is taken out from the warehouse 4 and sequentially taken to the inspection station and to the gate. A detailed description of these operations according to the preferred embodiment of the present invention follows, with reference to the flowcharts of FIGS. 6 and 7 respectively.

FIG. 6 is an operation flowchart for inspecting incoming cargo. In step 300, a vehicle loaded with cargo arrives at the gate for inspection using the gate management system 2. In step 302, the sensor 22a automatically detects vehicle information from an IC board located in the vehicle, and transmits the detected information to the server 20. In step 304, cargo delivery information that accompanies the cargo is compared with the cargo receipt schedule in the central management unit 1. The cargo delivery information includes contract number, delivery date and vehicle number. If the cargo delivery information does not match the cargo receipt schedule, then in step 306 the vehicle is refused passage and a rejection message is sent to the procurement department. If the cargo delivery information matches the cargo receipt schedule, then in step 308 the cargo is checked according to items listed in the cargo receipt schedule. The items include cargo name, specifications, quantity, and so on. If the cargo is not consistent with the listed items, then in step 310 the cargo is refused passage. If the cargo is consistent with the listed items, then in step 312 the operator retrieves the inspection requirements of the external system 5 from the cargo receipt notice system 11. The operator checks whether the cargo is flagged to be inspected in detail by the external organization. If the cargo is flagged, then in step 314 it is taken to a designated place for detailed inspection by the external organization. If after such inspection the cargo is not cleared by the external organization, then in step 315 the cargo is handled as directed by the external organization. If the cargo is cleared by the external organization or if the cargo is not flagged at all, then in step 316 the cargo is weighed on the weighbridge 23a. The measured weight is automatically transmitted to the server 20. In step 318, the cargo is allowed to pass through the gate and the operator digitally signs into the cargo receipt notice system 11 to confirm passage. In step 320, the cargo is taken to the inspection station. In the inspection station, in step 322, an operator firstly checks the cargo against the relevant record in the cargo receipt notice system 11. If the cargo is not consistent with the record in the cargo receipt notice system 11, then in step 324 the cargo is refused passage. If the cargo is consistent with the record in the cargo receipt notice system 11, then in step 326 the cargo is unloaded on the unloading ground 33a. In step 328, inspectors check the nature and quantity of the cargo according to the information displayed on the electronic displays 32a-32n. If the cargo is not acceptable, then in step 330 the cargo is refused passage. If the cargo is acceptable, then in step 332 the inspectors confirm acceptance via the IC card reader 34a. The cargo is then taken into the warehouse 4.

FIG. 7 is an operation flowchart for inspecting outgoing cargo. In step 400, the shipping department of the factory creates a shipping advice describing the required cargo. The shipping advice is created based on information in the cargo dispatch schedule in the cargo dispatch notice system 12. In step 402, the cargo listed in the shipping advice is taken out from the warehouse 4. In step 404, the cargo is sent to the inspection station. In step 406, an operator firstly checks the cargo listed in the shipping advice against a dispatch record in the cargo dispatch schedule in the cargo dispatch notice system 12. If the listed cargo does not match the cargo dispatch schedule, then in step 408 the operator refuses passage and notifies the shipping department accordingly. If the listed cargo matches the cargo dispatch schedule, then in step 410 the inspectors check the nature and quantity of the cargo according to the information displayed on the electronic displays 32a-32n. If the cargo does not meet passage requirements recorded in the cargo dispatch schedule, then in step 412 the cargo is refused passage. If the cargo meets the passage requirements, then in step 414 the inspectors confirm passage via the IC card reader 34b and seal the cargo. In step 416, the cargo is taken from the inspection station to the gate for weighing. In step 418, the cargo is weighed at the weighbridge 23b, and the measured weight is automatically transmitted to the server 20. In step 420, the sensor 22b automatically detects vehicle information from an IC board attached to a vehicle loaded with the cargo, and transmits the information to the server 20. An operator checks the vehicle information and the shipping advice against the dispatch record in the cargo dispatch schedule. The checked information includes shipping order number, delivery date and vehicle number. If the vehicle information or the listed cargo does not match the cargo dispatch schedule, then in step 422 the operator refuses passage. If the vehicle information and the listed cargo match the cargo dispatch schedule, then in step 424 the operator checks the cargo against the relevant record in the cargo dispatch schedule. The checked information includes cargo name, specifications, quantity, and so on. If the cargo is not consistent with the cargo dispatch schedule, then in step 426 the cargo is refused passage. If the cargo is consistent with the cargo dispatch schedule, then in step 428 the operator retrieves the inspection requirements of the external system 5 from the cargo dispatch notice system 12. The operator checks whether the cargo is flagged to be inspected in detail by the external organization. If the cargo is flagged, then in step 430 the cargo is taken to a designated place for detailed inspection by the external organization. If after such inspection the cargo is not cleared by the external organization, then in step 434 the cargo is handled as directed by the external organization. If the cargo is cleared by the external organization or if the cargo is not flagged at all, then in step 432 the cargo is allowed to pass through the gate. The operator digitally signs into the cargo dispatch notice system 12 to confirm passage.

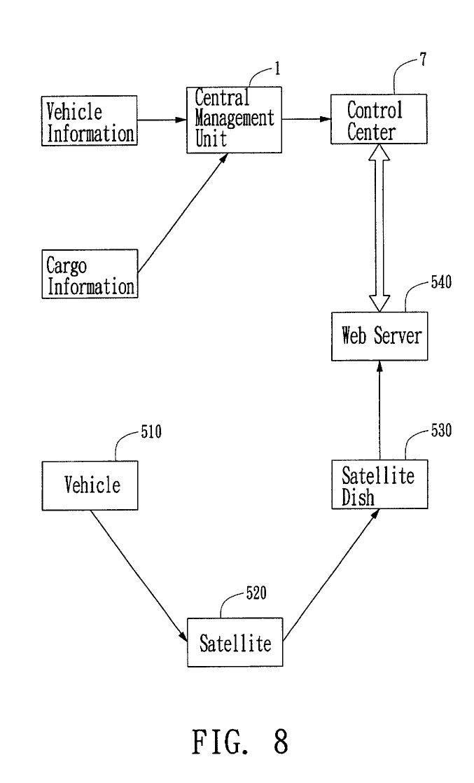

FIG. 8 is a schematic diagram of the GPS 6. A signal transmitter (not shown) is installed in each vehicle 510 loaded with cargo. The signal transmitter sends a signal which is received by a satellite 520. The satellite 520 then identifies a position of the vehicle 510 according to the signal, and broadcasts a satellite signal of the position which can be detected by a satellite dish 530. The satellite dish 530 is connected to the control center 7 by a web server 540, and can transmit the position to the control center 7 via a communications network. The control center 7 is connected to the central management unit 1 (see FIG. 1) which stores vehicle information and cargo information. Through the control center 7, an operator tracks the entire process of cargo delivery and identifies a cargo's position and delivery route.

The embodiment described herein is merely illustrative of the principles of the present invention. Other arrangements and advantages may be devised by those skilled in the art without departing from the spirit and scope of the present invention. Accordingly, the present invention is not to be limited to the above detailed description, but rather is to be defined by the spirit and scope of the claims which follow and their equivalents.

What is claimed is:

1. A system for managing cargo inspection, the system comprising:
a plurality of operation terminals for inputting cargo information;
a central management unit connected with the operation terminals via a communications network for receiving and storing the cargo information;
a gate management system connected to the central management unit via the communications network for controlling passage of the cargo according to the cargo information, the gate management system including a server for receiving the cargo information from the central management unit and storing cargo passage records, and at least one operation terminal for checking the cargo against the cargo information and updating the cargo passage records; and
an inspection management system connected to the central management unit via the communications network for inspecting the cargo according to the cargo information, the inspection management system including a server for receiving the cargo information from the central management unit and storing cargo inspection records, and at least one operation terminal for inspecting the cargo according to the cargo information and updating the cargo inspection records.

2. The system as claimed in claim 1, wherein the cargo information comprises contract number, cargo name, quantity, specifications, delivery date, and vehicle information.

3. The system as claimed in claim 1, wherein the gate management system further comprises a sensor for detecting information on a vehicle loaded with the cargo, a weighbridge for measuring a weight of the cargo, and a video camera for obtaining video views of cargo inspection.

4. The system as claimed in claim 3, wherein the sensor, the weighbridge, and the video camera are connected to the server in the gate management system and automatically transmit collected information to the server.

5. The system as claimed in claim 1, wherein the inspection management system further comprises a plurality of electronic displays connected to the server for displaying information on inspected cargo.

6. The system as claimed in claim 1, further comprising a global positioning system for tracking a delivery route and locating a position of the cargo.

7. The system as claimed in claim 6, further comprising a control center connected with the central management unit and the global positioning system for monitoring the entire process of cargo inspection and identifying the cargo's position and delivery route.

8. The system as claimed in claim 1, wherein the communications network comprises an intranet and the Internet.

9. A method for managing cargo inspection, the method comprising the steps of:
inputting incoming and outgoing cargo information to a central management unit via a communications network;
generating cargo receipt and dispatch schedules;
the central management unit obtaining cargo inspection requirements from an external system via the communications network;
integrating the cargo receipt and dispatch schedules and the cargo inspection requirements in the central management unit;
transmitting the integrated information to a gate management system for controlling passage of incoming and outgoing cargo; and
transmitting the integrated information to an inspection management system for controlling inspection of the incoming and outgoing cargo.

10. The method as claimed in claim 9, wherein the incoming and outgoing cargo information comprises contract number, cargo name, quantity, specifications, delivery date, and vehicle information.

11. The method as claimed in claim 9, further comprising the step of:
inputting cargo purchase requirements to the central management unit via the communications network.

12. The method as claimed in claim 11, further comprising the step of:
at least one supplier management information system obtaining the purchase requirements from the central management unit and inputting corresponding cargo delivery information into the central management unit via the communications network.

13. The method as claimed in claim 9, further comprising the step of:
providing in the gate management system a sensor for detecting information on a vehicle loaded with the cargo, a weighbridge for measuring a weight of the cargo, and a video camera for obtaining video views of cargo inspection.

14. The method as claimed in claim 9, further comprising the step of:
providing in the inspection management system a plurality of electronic displays connected to the server for displaying information on inspected cargo.

15. The method as claimed in claim 9, further comprising the step of:
providing a global positioning system for tracking a delivery route and locating a position of cargo.

16. The method as claimed in claim 15, further comprising the step of:
providing a control center connected with the central management unit and the global positioning system for monitoring the entire process of cargo inspection and identifying the cargo's position and delivery route.

17. The method as claimed in claim 9, wherein the communications network comprises an intranet and the Internet.

18. A method for managing incoming cargo inspection, the method comprising the steps of:
inputting incoming cargo information to a central management unit via a communications network;
generating a cargo receipt schedule;
the central management unit obtaining cargo inspection requirements from an external system via the communications network;
integrating the cargo receipt schedule and the cargo inspection requirements in the central management unit;
transmitting the integrated information to a gate management system for controlling passage of incoming cargo; and
transmitting the integrated information to an inspection management system for controlling inspection of the incoming cargo according to the integrated information.

19. The method as claimed in claim 18, further comprising the step of:
providing a global positioning system for tracking a delivery route and identifying a location of cargo.

20. The method as claimed in claim 19, further comprising the step of:
providing a control center connected with the central management unit and the global positioning system for monitoring the entire process of cargo inspection and identifying the cargo's location and delivery route.

21. A method for managing outgoing cargo inspection, the method comprising the steps of:
inputting outgoing cargo information to a central management unit via a communications network;
generating a cargo dispatch schedule;
the central management unit obtaining cargo inspection requirements from an external system via the communications network;
integrating the cargo dispatch schedule and cargo inspection requirements in the central management unit;
transmitting the integrated information to a gate management system for controlling passage of outgoing cargo; and
transmitting the integrated information to an inspection management system for controlling inspection of the outgoing cargo according to the integrated information.

22. The method as claimed in claim 21, further comprising the step of:
providing a global positioning system for tracking a delivery route and identifying a location of cargo.

23. The method as claimed in claim 22, further comprising the step of:
providing a control center connected with the central management unit and the global positioning system for monitoring the entire process of cargo inspection and identifying the cargo's location and delivery route.

24. A method for managing incoming/outgoing cargo inspection comprising the steps of:
providing incoming/outgoing cargo information;
generating a cargo receipt/dispatch schedule;
providing a gate management system and an inspection management system; and
having the incoming cargo pass the gate management system first and the inspection management system successively but having the outgoing cargo pass the inspection management system first and the gate management system successively; wherein
the gate management system checks schedule consistence, external examination requirement and weight consistence for determining cargo passage or not, or even to an external organization, and the inspection management system checks schedule consistence and cargo content for determining cargo passage or not.
